(19) United States
(12) Patent Application Publication
(10) Pub. No.: US 2023/0407703 A1
(43) Pub. Date: Dec. 21, 2023

(54) ESCALATING STEP LADDER SYSTEM

(71) Applicants: Gwendolyn Jenkins-Allen, Houston, TX (US); Robert L. Allen, Houston, TX (US)

(72) Inventors: Gwendolyn Jenkins-Allen, Houston, TX (US); Robert L. Allen, Houston, TX (US)

(21) Appl. No.: 17/727,069

(22) Filed: Apr. 22, 2022

Related U.S. Application Data
(60) Provisional application No. 63/178,544, filed on Apr. 23, 2021.

(51) Int. Cl. E06C 1/39; E06C 7/16; E06C 1/26; E06C 7/18; E06C 1/397; E06C 7/14

(52) U.S. Cl. CPC E06C 1/39; E06C 7/16; E06C 7/14; E06C 7/185; E06C 1/397; E06C 1/26

(57) ABSTRACT

An automated system for raising and lowering a person to various desired levels enables the person to more comfortably and safely perform activities and tasks that require them to be at an elevated position relative to floor or ground surface. This system can comprise a lift platform attached to a series of vertical rails. The lift platform moves vertically along the rails, a user elevates to a desired position or height to perform the intended task. This system enables the user to determine their exact position instead of being at predetermined heights from using conventional devices such as ladders or stools. Once on the lift platform, a user can further secure themselves to the lift platform with a brace attached to the vertical rails. This brace would fit around the user's back and side straps would secure the brace to the vertical rails of the system.

### CROSS-REFERENCE TO RELATED APPLICATION

This patent application relates to and claims priority from provisional patent application No. 63/178,544, filed on Apr. 23, 2021. The contents of which are incorporated herein by reference.

### FIELD

This invention relates to a lifting device having a platform that automatically moves vertically as a person desires. More specifically, this invention relates to a step ladder with an automatically moving platform in a linear vertical direction. More particular, this invention relates to a step ladder that can raise and lower a person standing on the ladder platform without the person needing to take a step.

### BACKGROUND

Many home tasks require a person to elevate to perform the task. Tasks such as hanging a picture on the wall, retrieving an item from the top of a shelf, or changing a light bulb can require the use of a step ladder or step stool. In these cases, a person only needs to elevate a short distance (usually one to three feet) to accomplish the task. Although the elevation height in many instances is minimal, there are still risks involved whenever a person elevates (above the floor) to perform the activity. Depending on the type of step or rung on the stool or ladder, while taking a step, a person could miss the step or a foot could slip, causing the person to lose their balance and fall. Besides, while standing on the step ladder, some activities such as reaching or leaning may cause a person weight to shift which can result in a loss of their balance. Also, as a person ages, their ability to maintain their balance while stepping up or down the ladder can be questionable. As a result, some senior persons are reluctant or at best uncomfortable using stools and step ladders to elevate when needed for a task or job. Climbing these ladders or stools also requires the physical act of taking steps which some people may struggle to do.

These actions require the exertion of physical energy to take climbing steps and, as mentioned, risk losing one's balance. Many people have some physical limitation that makes repeatedly stepping up and down a ladder very challenging and, in some instances, dangerous. Traditional ladders and stools also have steps at fixed height distances. Depending on the application, these fixed distances may not be the desired or needed height for a task. As a result, the person may need to stretch to reach the desired position. As mentioned, these acts could bring about balance issues.

There have been past efforts to address this issue. U.S. Pat. No. 5,145,031 to Sprunger describes an electric ladder. This ladder is adjustable and comprises a pair of side supports, a device for retaining the supports in a spaced relationship, a rung, a device for slidably mounting the rungs in the supports, and a device for moving the rung along with the supports for adjusting the position of the rung.

U.S. Pat. No. 8,011,473 to Gregersen describes a motorized stepladder. This stepladder comprises a front frame and a rear frame, each formed of a pair of spaced side rails. A motor-driven step is slidably mounted on the front frame side rails. A remote unit controls the motor allowing a worker to automatically raise and lower the step when accessing an elevated area.

The physical construction of the traditional step ladders and physical limitations and concerns of some users can make activities requiring the use of a step ladder or stool a challenge and concern for some people. There remains a need for a step ladder that eliminates the need for a person to take steps or stand and balance on thin, narrow, and round ladder rungs. When climbing or working without concern for slipping or falling off the ladder or stool.

### SUMMARY

This invention provides an escalating step ladder. This device has a moveable standing platform on which a person will stand. This moveable platform attaches to support legs that form the convention structural frame of the device. This invention can also contain a mechanical or electrical means to automatically raise and lower the standing along the device support legs to heights desired by the user. A power system supplies power to move, raise and lower the platform and person standing on the platform. The present invention can also have a safety strap to secure a person while standing on the platform to maintain balance. The support legs can have designs of various configurations. The standing platform can have multiple designs including a fold out section to provide more platform surface for the person standing on the device.

### DESCRIPTION OF THE DRAWINGS

FIG. 1 is an illustration of an escalating step ladder of the present invention.

FIG. 2 is an alternate illustration of an escalating step ladder of the present invention.

FIG. 3 illustrates the support bar on top that can be pulled up if needed to activate the ladder manually.

FIG. 4 is an illustration of the charging pad and collapsing roller/wheels.

FIG. 5 is an illustration of the collapsing step feature of the standing platform of the present invention.

FIG. 5a is an illustration of the expandable collapsing step feature of the standing platform of the present invention.

FIG. 6a is an image of an attachable tray in an alternate embodiment of the present invention.

FIG. 6b is an illustration of the attachable tray engaged with the support bar at the top of the escalating step ladder of the present invention.

FIG. 7 is an illustration of an attachable and optional support brace of the present invention.

FIG. 8 illustrates an alternate embodiment of the present invention showing the support brace attached to the step ladder.

FIG. 9 illustrates an outlet in support of the present invention to facilitate the supply of power to the means, which automatically moves the standing platform.

### DETAILED DESCRIPTION OF THE INVENTION

The present invention provides a step ladder with a step platform that automatically moves up and down along the support legs to a height desired by the user. With this invention, once the user steps onto the platform, the user does not need to take any additional steps to move vertically on the ladder. As a result, the user does not have concerns about falling or losing his or her balance while trying to step or stand on the ladder.

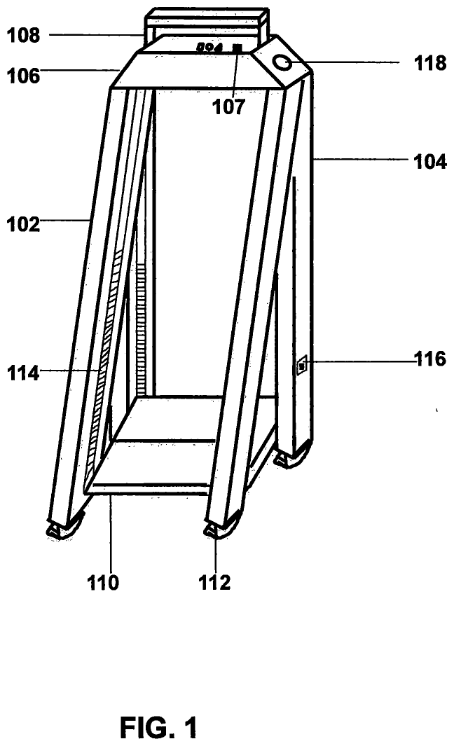

FIG. 1 illustrates the preferred embodiment of the present escalating step ladder invention. This ladder invention comprises two sets of vertical support legs 102 and 104. The tops of these support legs connect to a top base 106. The top base can contain an optional attachable tray 108. This tray can have multiple applications, such as serving as a place to lay tool items when a person is working. The user can raise this bar up and lower it down. The collapsible standing platform 110 attaches to the sets of support legs 102 and 104 at the support legs' lower end. The bottom end of the support legs can contain rollers or wheels 112 to facilitate the ladder movement. These wheels can have the capability to lock into place to address safety concerns when the user desires to keep the ladder in a stationary position. In an alternate embodiment of this invention, the rollers collapse into the support legs. This invention can have a mechanical system of grooves or threads 114 positioned in the inner side of the support legs to move the standing platform in vertical directions. The grooves or threads attach to the support platform and serve as a track for the standing platform's movement. A gear system attached to the grooves or threads and connected to an electric motor can initiate the force to raise and lower the standing platform as desired by the user. An electrical plug 116 on one of the support legs can connect the motor with an external electrical power source to power the motor and move the standing platform. Although not shown, an electric motor can be housed at the base of one of the legs or beneath the standing platform. Mechanical means such as rods can connect the motor to the gear system to provide the mechanical force required to raise and lower the standing platform. A manual override device 118 can be a control button or lever. This device allows the user to manually move the standing platform in the event the electrical controls fail. The controller device 107 on top base 106 connects to the electric motor or another power source to enable the user to control the height of the standing base and the vertical movement of the standing base.

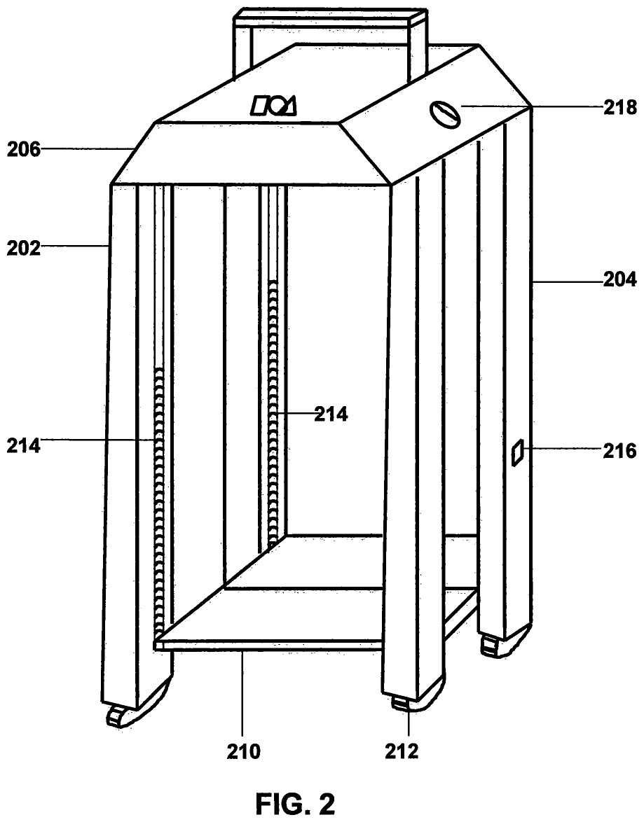

FIG. 2 is an alternate embodiment of the escalating step ladder of the present invention. In this embodiment, the sets of leg support 202 and 204 are all in a vertical position. This configuration differs from the support leg configuration of FIG. 1. In FIG. 1, at least one pair of support legs is in an angled position. Many conventional ladders extend outward into an “A” type configuration. The design in FIG. 2 is in part to simplify the means 214 to raise and lower the standing platform 210.

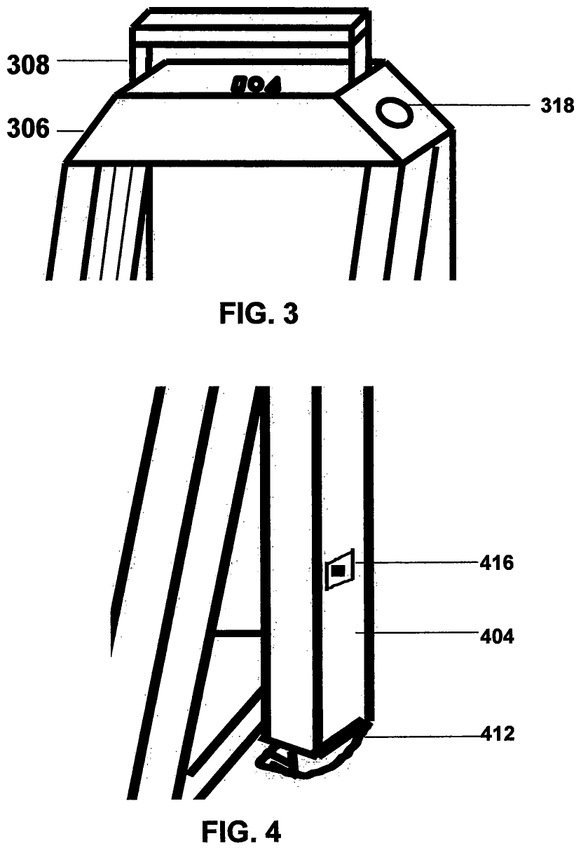

FIG. 3 shows the top base 306 and the attachable support tray bar 308 on top. A user can pull up this attachable tray bar if needed to activate the ladder manually. As mentioned, the ladder is designed to be automatically activated and controlled with the controller 318 positioned on the top base 306. However, this invention does have a manual control option if the automated control system fails to function correctly. With the manual control option, the user can disengage the motor and gear assembly that raises and lowers the standing platform. The user can physically adjust the device as desired. This ability would be extremely useful in cases when the automatic operational option malfunctions.

FIG. 4 is a close-up view of the charging pad 416 and collapsing roller/wheels 412. As mentioned, the charging pad 416 is incorporated into one of the support legs 404. The charging pad is the means through which power is supplied to raise and lower the standing platform automatically. As mentioned, the power source (electrical motor) can be positioned in or near the base of one of the support legs.

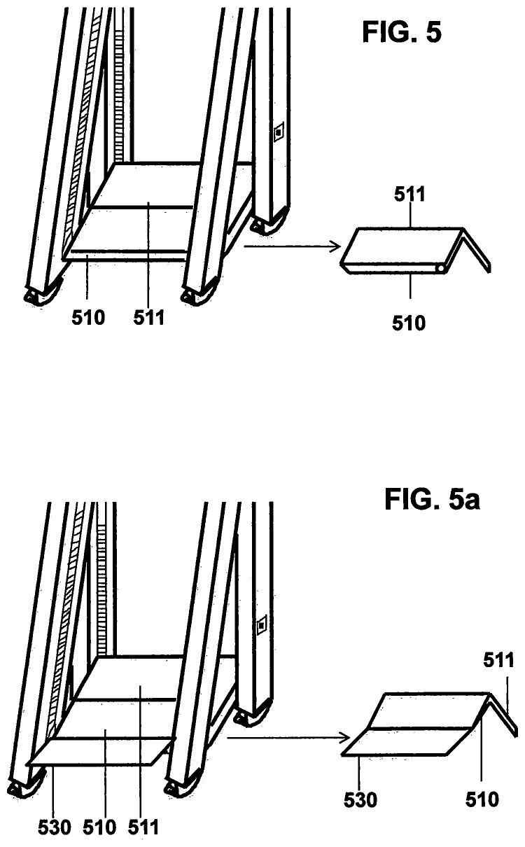

FIG. 5a shows the collapsing step feature of the standing platform 510 of the present invention. In this invention, the support legs and the standing platform can collapse down when the ladder is not in use for storage purposes. A fold 511 in the standing platform 510 provides the capability of the standing form to collapse. FIG. 5b shows an embodiment with the standing platform having three sections 511, 510 and 530. Section 530 attaches to section 510 and provides additional surface on which a person may stand. This section 530 can fold over section 510 and fit on top of section 510 during regular use, if a user does not desire the additional surface area on which to stand.

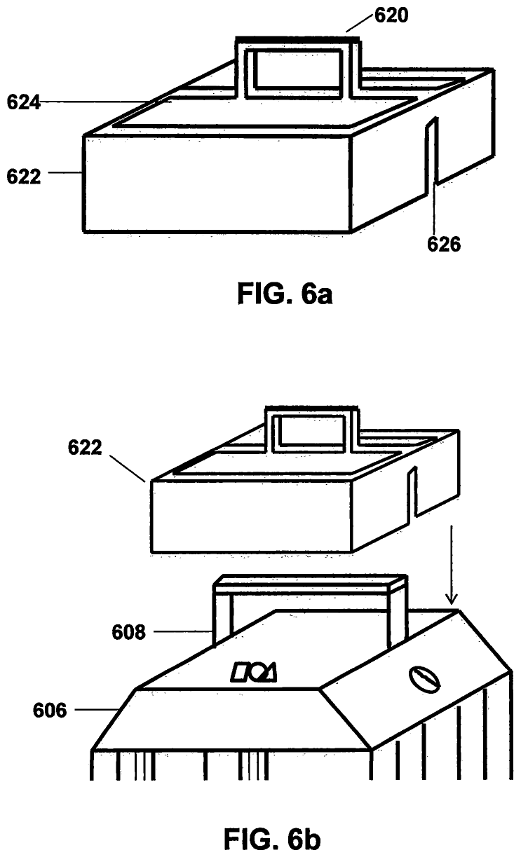

FIGS. 6a and 6b are images of an attachable tray in an alternate embodiment of the present invention. As shown, this tray attaches to the 622 to the tray 608, which is attached to the top base 606. This attachable tray has a handle 620, a top surface 624, and side grooves 626 To enable the tray to fit over the tray bar easily. This tray can serve as a place on which the user can set items once retrieved. In addition, for other applications such working on home improvement projects, the user can place or store useful tools on this tray.

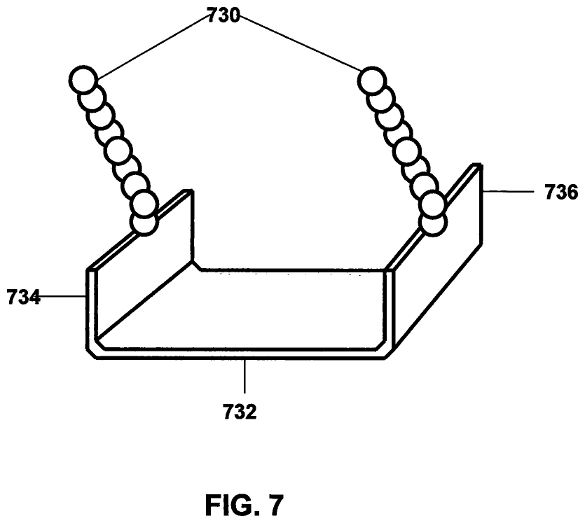

As mentioned, a primary concern with performing activities that require a person to elevated is maintaining one's balance while elevated. To further address that concern, FIG. 7 shows the optional attachable support brace of the present invention. This optional piece has a back support 732 and flexible attaching arms 730 to secure the back support to the ladder legs. This piece also has side support straps or chains 734 and 736 that extend outward from the back support. These side supports create a more confined space and further stability in the back support. This support brace will provide additional support to a person on the ladder and prevent them from falling backward off the ladder. This feature may be particularly beneficial to persons who have concerns about losing their balance and falling.

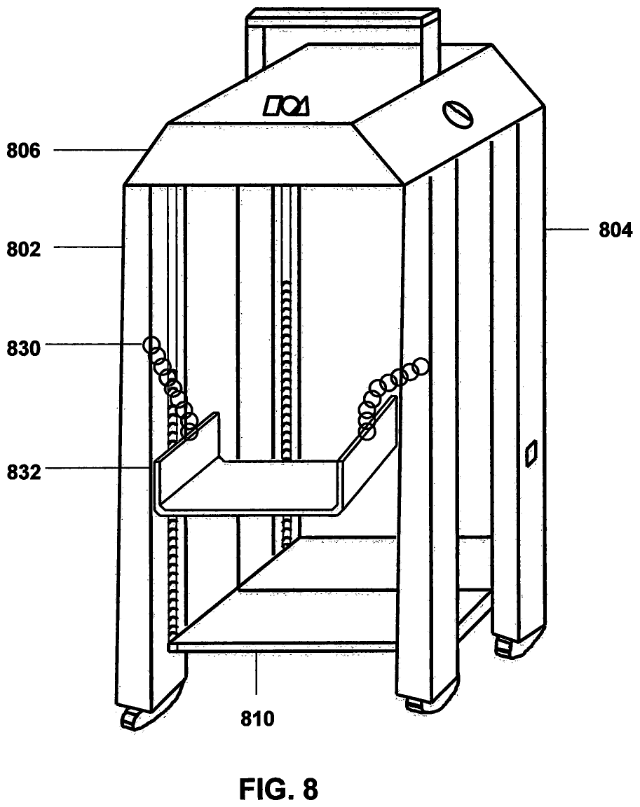

FIG. 8 illustrates an alternate embodiment of the present invention showing the support brace 832 attached to the step ladder through connecting arms 830. In full application, the ladder support legs 802 and 804 attach to the top base 806. As the person moves up the ladder on the standing platform 810, the attaching arms 830 can also enable the support brace to move with the person as they raise or lower the standing platform.

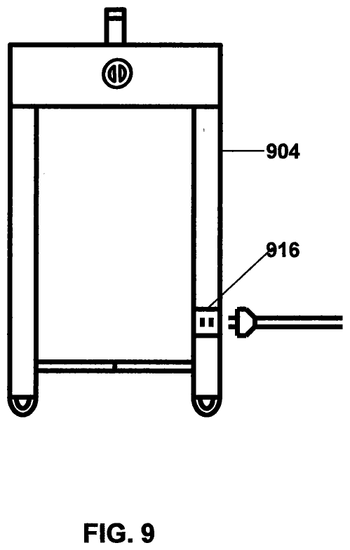

FIG. 9 illustrates an outlet supporting the present invention to facilitate the supply of power to the means, which automatically moves the standing platform. In the present invention, the power source can be a mobile source such as a battery. The power source can also be an external source, such as power from a wall outlet. As shown, the power outlet 916 and other connections can be positioned in one of the support legs 904. Through this outlet 916, one can power the electric motor or power means directly from the wall power source. However, one can also use outlet 916 to charge a battery power source.

While the present invention has been illustrated by the description of embodiments thereof, and while the embodiments have been described in some detail, it is not the intention of the applicant to restrict or in any way limit the scope of the invention to such information. Additional advantages and modifications will readily appear to those skilled in the art. The invention, in its broader aspects, is not limited to the specific details, representative apparatus and methods, and illustrative examples shown and described. Accordingly, departures may be made from such details without departing from the spirit or scope of the applicant's general inventive concept.

I claim:

1. An automated system for vertically elevating a user to a desired height level for performing activity comprising:
a frame structure comprising at least three vertical leg structures, said legs being linear and having an upper end and a lower end and being connected to each other to sustain support when weight is placed on them;
a foldable stand structure connected and supported by said vertical leg structures, said stand structure being capable of moving vertically along said leg structures while supporting a user standing on said stand structure;
a power system connected to said stand structure for supplying mechanical power to raise and lower said stand structure while supporting a user on said stand structure; and
a controller device to enable a user standing on said stand structure to control speed and height of said stand structure

2. The automated system for vertically elevating a user to a desired height level as described in claim 1 wherein said frame structure further comprises at least four said vertical leg structures positioned to form a rectangular structure relative to each other and wherein each vertical leg of said frame structure is connected to said foldable stand structure such that said foldable stand structure can move vertically relative to the position of said vertical leg structures.

3. The automated system for vertically elevating a user to a desired height level as described in claim 2, wherein said power system further comprises a gear system connected to an electric motor, said gear system also being connected to each of said vertical leg structures and said foldable stand structure, such that when the electric motor supplies power to the gear system, the gear system will cause said stand structure to vertically and transverse along said vertical leg structures enabling a user supported by said frame structure to move in a vertical direction.

4. The automated system for vertically elevating a user to a desired height level as described in claim 3 further comprising transporting grooves in said vertical leg structures that engage with said gear system to facilitate vertical movement of the said stand structure.

5. The automated system for vertically elevating a user to a desired height level as described in claim 3 further comprising a back support element, said back support element having a smooth flat surface with two ends to engage a user's back and support straps attached to each end of said back support element, said support straps also attached to vertical leg structures of said frame structure to support user while on said foldable stand structure.

6. The automated system for vertically elevating a user to a desired height level as described in claim 2 further comprising rollers attached to the lower end of each said vertical leg structures, said rollers being able to facilitate easier movement of said frame structure and said rollers being able to lock into place to maintain a stationary position of said frame structure.

7. The automated system for vertically elevating a user to a desired height level as described in claim 5 wherein said foldable stand structure comprises two base folding sections and an extension section connected to one of the base folding sections and wherein said extension section can fold over onto the base folding section connected to it.

8. The automated system for vertically elevating a user to a desired height level as described in claim 2 further comprising a top base positioned on the top end of said vertical legs of said frame structure, said top base comprising four base elements, each base element having a top edge, bottom edge and two side edges, said four sides being connected to each other at the side edges, a base platform comprising a flat surface element connected to the top sides of the connected base elements, said base platform providing a location to set items during a user's activity.

9. The automated system for vertically elevating a user to a desired height level as described in claim 8 further comprising a tray element slidably attached and secured to said base platform, said tray element attached to said base platform through an opening in said base platform such that a user can extend said tray element upward from said and lock the tray in place and user can retract said tray through the opening in the base platform such that a tray element top will fill in the opening in said base platform when said try element is not in use.

10. The automated system for vertically elevating a user to a desired height level as described in claim 3 further comprising an electrical plug inlet to which said electric motor is connected to facilitate supplying electrical power to said electric motor.

11. The automated system for vertically elevating a user to a desired height level as described in claim 2 wherein said vertical leg structures of said frame structure further comprises an ‘A’ configuration.

12. The automated system for vertically elevating a user to a desired height level as described in claim 8 further comprises a controller device connected to said electric motor to enable a user to remotely control lifting and lowing functions of said foldable stand structure.

13. The automated system for vertically elevating a user to a desired height level as described in claim 12 further comprising a manual override to control lifting and lowing functions of said foldable stand structure.

14. An automated system for vertically elevating a user to a desired height level for performing activity comprising:
a frame structure comprising at least four vertical leg structures, said legs being linear and forming a frame structure in the form of an ‘A’ frame configuration and having an upper end and a lower end and being connected to each other to sustain support when weight is placed on them;
a foldable stand structure connected and supported by said vertical leg structures of said frame structure, said foldable stand structure being capable of moving vertically along said vertical leg structures while supporting a user standing on said stand structure, said foldable stand structure comprises two base folding sections and an extension section connected to one of the base folding sections and wherein said extension section can fold over onto the base folding section connected to it;
a back support element, said back support element having a smooth flat surface with two ends to engage a user's back and support straps attached to each end of said back support element, said support straps also attached to vertical leg structures of said frame structure to support user while on said foldable stand structure.
a power system connected to said stand structure for supplying mechanical power to raise and lower said stand structure while supporting a user on said stand structure, said power system comprising a gear system connected to an electric motor, said gear system also being connected to each of said vertical leg structures and said foldable stand structure, such that when the electric motor supplies power to the gear system, the gear system will cause said stand structure to vertically and transverse along said vertical leg structures enabling a user supported by said frame structure to move in a vertical direction; and
a controller device to enable a user standing on said stand structure to control speed and height of said stand structure

15. The automated system for vertically elevating a user to a desired height level as described in claim 14 further comprising a top base positioned on the top end of said vertical legs of said frame structure, said top base comprising four base elements, each base element having a top edge, bottom edge and two side edges, said four sides being connected to each other at the side edges, a base platform comprising a flat surface element connected to the top sides of the connected base elements, said base platform providing a location to set items during a user's activity.
